(19) United States
(12) Patent Application Publication
(10) Pub. No.: US 2007/0059995 A1
(43) Pub. Date: Mar. 15, 2007

(54) Single control roman tub faucet

(76) Inventors: Mark S. Bloom, Mission Viejo, CA (US); Walter H. Strader, Coto de Caza, CA (US); Li Chen, Brea, CA (US)

Correspondence Address: THE BLACK & DECKER CORPORATION, 701 EAST JOPPA ROAD, TW199, TOWSON, MD, 21286, US

(21) Appl. No.: 11/516,121

(22) Filed: Nov. 16, 2006

Related U.S. Application Data
(62) Division of application No. 10/433,282, filed on Aug. 11, 2003.
(60) Provisional application No. 60/325,710, filed on Oct. 1, 2001.

(51) Int. Cl. H01R 13/73

(52) U.S. Cl. 439/894

(57) ABSTRACT

A single control roman tub faucet comprises a handle, a lever coupled to the handle, and a valve coupled to the lever. The valve is configured to provide a maximum flow rate of at least 7.8 GPM. A cartridge valve has a valve base and a lower disk. The valve base includes an upper surface and a lower surface and a water passage extending between the upper and lower surfaces. The outlet end of the passage has a larger cross-sectional area than the inlet end. The lower disk includes an inlet sized to match the outlet end of the passage. The cross section of the passage is generally arcuate and is defined by parallel side walls and non-parallel end walls.

The present invention relates to roman tub faucets in general and to single lever roman tub faucets in particular.

### BACKGROUND OF THE INVENTION

Standard single control faucet cartridges provide typical flow rates of about 2.5 GPM. Roman tub faucet flow rates, on the other hand, are typically required to be in the range of 12-18 GPM in order to fill the tub in a reasonable amount of time.

To date, manufacturers have been unable to provide single lever roman tub faucets due to an inability to provide the flow rates desired by consumers using a cartridge valve. Scaling up a conventional cartridge valve is not a viable solution for several reasons. One reason that attempts to scale up a conventional cartridge valve for use with a roman tub have met with failure is because of excessive noise related to the increased flow rate through a valve designed for lower flow rates.

A second reason relates to the amount of valve disk movement relative to the amount of handle movement. Merely scaling up the size of a conventional cartridge valve moves the pivot point of the operating lever of the cartridge, which increases the amount of disk movement responsive to a given amount of handle movement. A conventional cartridge valve uses about 25° of handle movement between the full off and full on positions. However, that same 25° of handle movement in a scaled up version of a conventional cartridge valve corresponds to a greater amount of disk movement, which requires a physically larger cartridge. A larger cartridge, in turn, requires a larger faucet that is unacceptable from an aesthetic standpoint. In addition, a larger faucet costs more to manufacture.

### SUMMARY OF THE INVENTION

The present invention provides a single control roman tub faucet using a conventional-sized cartridge, thereby overcoming the above-noted problems.

A single control roman tub faucet according to the present invention comprises a handle, a lever coupled to the handle, and a valve coupled to the lever. The valve is configured to provide a maximum flow rate of at least 7.8 GPM.

According to one aspect of the invention, a single control roman tub faucet comprises a cartridge valve having a valve base and a lower disk. The valve base has an upper surface and a lower surface and a water passage extending between the upper and lower surfaces. The outlet end of the passage has a larger cross-sectional area than the inlet end. The lower disk includes an inlet sized to match the outlet end of the passage.

In a preferred embodiment of the invention, the passage includes parallel side walls and non-parallel end walls. The cross section of the passage is generally arcuate.

These and other features and advantages of the present invention will become apparent from the following description when viewed in accordance with the accompanying drawings and appended claims.

### BRIEF DESCRIPTION OF THE DRAWINGS

FIG. 1 is a perspective view of a single control roman tub faucet for use with the cartridge valve of the present invention.

FIG. 2 is a perspective view of an assembled cartridge valve for use in the faucet of FIG. 1.

FIG. 3 is an exploded view of the cartridge valve of FIG. 2.

FIG. 4 is a perspective view of the valve base of the cartridge valve of FIG. 2.

FIG. 5 is a bottom plan view of the valve base.

FIG. 6 is a top plan view of the valve base.

FIG. 7 is a side view of the valve base.

FIG. 8 illustrates a lower gasket for use with the valve base.

FIG. 9 illustrates an upper gasket for use with the valve base.

FIG. 10 is a perspective view of the lower disk of the cartridge valve of FIG. 2.

FIG. 11 is a top plan view of the lower disk.

FIG. 12 is a bottom plan view of the lower disk.

FIG. 13 is a bottom perspective view of the upper disk of the cartridge valve of FIG. 2.

FIG. 14 is a top plan view of the upper disk.

FIG. 15 is a bottom plan view of the upper disk.

FIG. 16 is a side view of the upper disk.

### DETAILED DESCRIPTION OF THE DRAWINGS

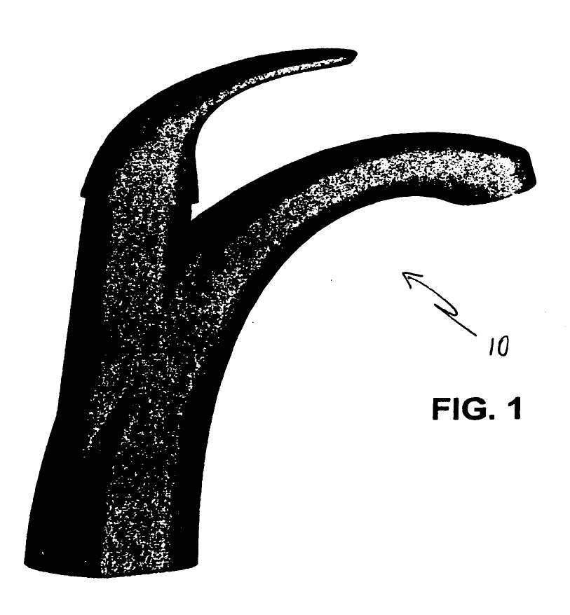

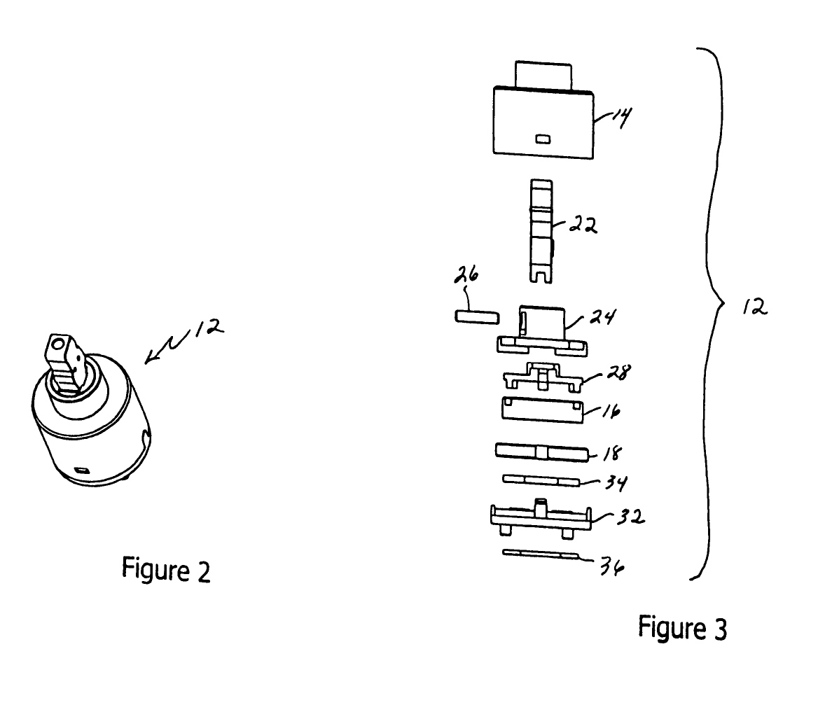

An single control roman tub faucet 10, illustrated in FIG. 1, uses a cartridge valve 12 illustrated in FIGS. 2-3. The cartridge valve 12 includes a housing 14, an upper disk 16, a lower disk 18, and an operating lever 22 connected to a bushing 24 by a pivot pin 26. The bushing 24 is connected to a valve coupling 28 that couples the bushing 24 to the upper disk 16, thereby allowing the lever 22 to move the upper disk 16 relative to the lower disk 18. A valve base 32 attaches to the bottom of the housing 14 and cooperates with the housing 14 to retain the bushing 24, the valve coupling 28, the upper disk 16 and the lower disk 18 in their respective positions. An upper gasket 34, illustrated in FIG. 9 provides a watertight seal between the valve base 32 and the lower disk 18 and a lower gasket 36, illustrated in FIG. 8, provides a watertight seal between the valve base 32 and water supply conduits (not shown). In preferred embodiments, the upper and lower disks 16, 18 are made from a conventional ceramic material.

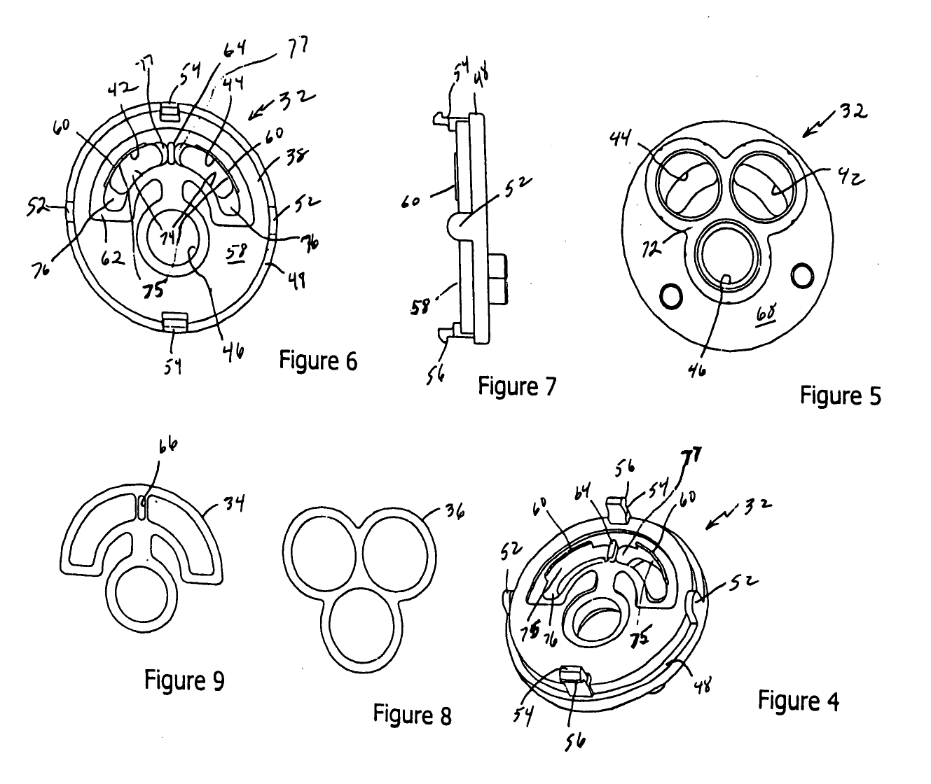

The valve base 32, illustrated in FIGS. 4-7 is a circular plate 38 with a pair of water inlet openings 42, 44, and an outlet opening 46. The plate 38 includes a radially outwardly extending flange 48, a pair of alignment tabs 52 and a pair of locking tabs 54 extending upwardly from the flange 48. The locking tabs 54 include fingers 56 for engaging the housing 14 to retain the valve base 32 in position. The upper surface 58 of the plate 38 includes a gasket channel 62 extending around the inlet openings 42, 44 and the outlet opening 46 for receiving the upper gasket 34. A positioning tab 64 extends upwardly between the inlet openings 42, 44 and engages a slot 66 formed in the upper gasket 34 to facilitate positioning the upper gasket 34 and to retain it in position. The upper surface 58 further includes an arcuate ridge 60 extending along the outside edge of each inlet opening 42, 44 to retain the upper gasket 34 in the gasket channel 62. The lower surface 68 of the plate includes a gasket channel 72 that receives the lower gasket 36.

The inlet openings 42, 44 are arcuate and include generally parallel side walls 74, 75 and sloped end walls 76, 77 at the ends of the openings. The end walls 76, 77 slope circumferentially outwardly from the lower surface 68 of the plate 38 to the upper surface 58, so that the cross-sectional area of the inlet openings 42, 44 at the upper surface 58 is greater than the cross-sectional area at the lower surface 68. Thus, the inlet openings 42, 44 are larger at the interface between the valve base 32 and the lower disk 18. The enlarged openings at the interface improves cartridge response to movement of the faucet handle and the sloped walls 76 may help reduce flow noise.

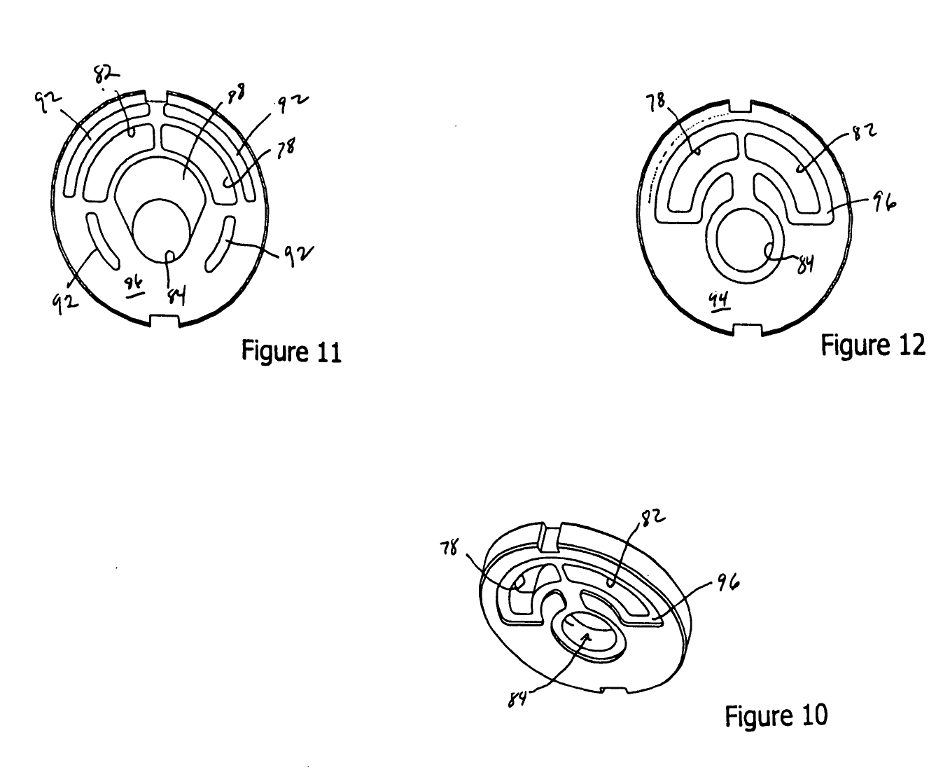

The lower disk 18, illustrated in FIGS. 10-12, includes a pair of arcuate inlet openings 78, 82 that are aligned with, and sized to match, the enlarged inlet openings 42, 44 at the upper surface 58 of the valve base 32. An outlet opening 84 is aligned with, and sized to match, the outlet opening 46 of the valve base 32. The upper surface 86 of the lower disk 18 includes an arcuate recess 88 that extends along an arc of about 52° centered on the inlet openings 78, 82, and from adjacent the inlet openings 78, 82 to the outlet opening 84. The upper surface 86 further includes a plurality of arcuate lubricant channels 92. The lower surface 94 of the lower disk 18 includes a gasket channel 96 that matches and cooperates with the upper gasket channel 62 of the valve base 32 for receiving the upper gasket 34.

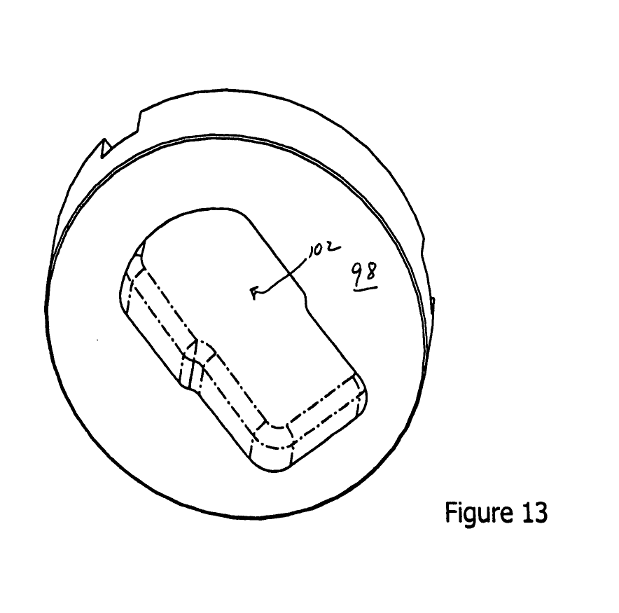

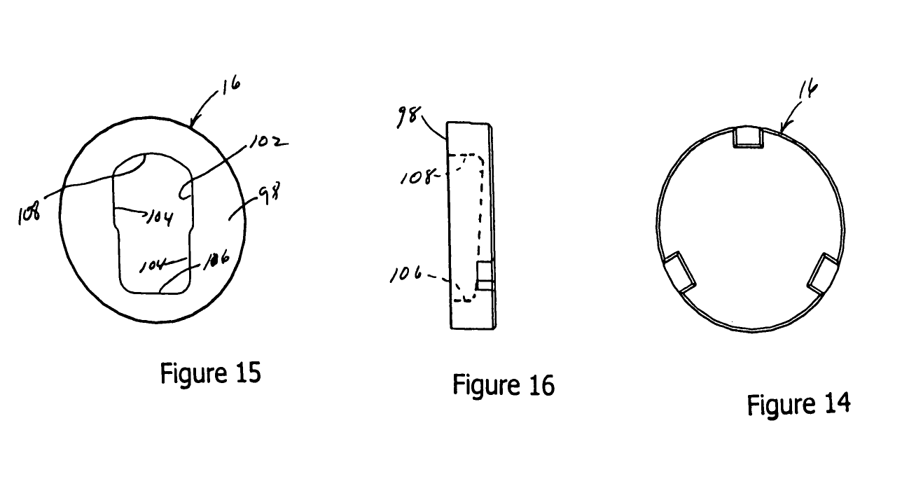

The upper disk 16, illustrated in FIGS. 13-16, includes a lower surface 98 that sealingly engages the upper surface 86 of the lower disk 18 and includes a recess 102. The recess 102 includes a pair of stepped side walls 104, a straight end wall 106 and a curved end wall 108 that closely matches the curvature of the inlet openings 78, 82. As illustrated in FIG. 16, the recess 102 has an uneven depth, with the deeper portion adjacent the curved end wall 108. The slope of the recess facilitates the change in flow direction of the water from the inlet openings 78, 82 to the outlet opening 84 and may help reduce flow noise.

In the off position, the upper disk 16 is positioned so that the recess 102 covers the outlet opening 84 with the curved end wall 108 adjacent to, but not overlapping, the inlet openings 78, 82. As the faucet handle is moved to the on position, the recess 102 begins to overlap one or both of the inlet openings 78, 82, providing a cold water passage and/or a hot water passage from the inlet openings 78, 82 to the outlet opening 84. As in conventional single control valves, the amount of hot and cold water is controlled by the lateral position of the handle.

The cartridge valve of the present invention has been tested by an independent laboratory with the following results:

| Valve Operation | | |
|---|---|---|
| (% Max. Open) | Flow Rate | Flow Percentage |
| 100% Open | 12.8 GPM | 100% |
| 50% Open | 7.1 GPM | 55.47% |

| | | | Flow Percentage |
|---|---|---|---|
| Valve Mix Position | | Flow Rate (GPM) | (% Max. Flow) |
| −100% | (Full Cold) | 8.0 | 62.5% |
| −50% | | 11.0 | 85.9% |
| 0% | (Middle | 12.8 | 100% |
| | Position) | | |
| +50% | | 10.7 | 83.6% |
| +100 | (Full Hot) | 7.8 | 60.9% |

Notes:
The test was conducted at 50% and 100% only, 60 psi flowing pressure.
Valve position at the middle of mixing hot and cold position was considered 0% max. rotation.
The negative and positive % max. rotation were turning the valve to cold and hot position, respectively.

The above data shows that the present invention provides a single control roman tub faucet with a flow rate of up to 12.8 GPM, which is within the range of flow rates of conventional, dual control roman tub faucets. Importantly, the flow rates are achieved with a cartridge valve that has an outside diameter of about 1.67 inches.

While the present invention has been described with reference to particular preferred embodiments, one skilled in the art will readily recognize from the foregoing discussion and accompanying drawings and claims, that changes, modifications and variations can be made in the present invention without departing from the spirit and scope thereof as defined in the following claims.

1-7. (canceled)

8. A single control roman tub faucet comprising:
a cartridge valve having a valve base and a lower disk, the valve base having an upper surface and a lower surface and at least one water passage extending between the upper and lower surfaces, the outlet end of the at least one water passage having a larger cross-sectional area than the inlet end, the lower disk having an inlet sized to match the outlet end of the at least one passage.

9. The faucet of claim 8 wherein the at least one passage includes parallel side walls and non-parallel end walls.

10. (canceled)

11. The faucet of claim 8 further including a ridge disposed adjacent the at least one water passage.

12. The faucet of claim 8 wherein the at least one water passage includes two water passages and the valve base further includes means for positioning a gasket.

13. The faucet of claim 12 wherein the means for positioning includes a positioning tab and a ridge disposed adjacent the two water passages.

14. A single control roman tub faucet comprising:
a cartridge valve having a base, an upper disk, and a lower disk, the base and lower disk cooperating to define an inlet passage and an outlet passage and the upper disk including a recess that cooperates with the lower disk to define a passage connecting the inlet passage and the outlet passage, the recess having a larger cross section at the inlet passage than at the outlet passage.

15. The faucet of claim 14 wherein the base defines a portion of the inlet passage, the defined portion being larger at an upper surface of the base than at a lower surface of the base.

16. The faucet of claim 14 wherein the inlet passage and outlet passage cooperate to provide a maximum flow rate of at least 7.8 GPM.

17. The faucet of claim 15 wherein the inlet passage and outlet passage cooperate to provide a maximum flow rate of at least 10.0 GPM.

18. The faucet of claim 14 wherein the maximum outside diameter of the cartridge valve is less than 1.85 inches.

19. The faucet of claim 14 wherein the maximum outside diameter of the cartridge valve is less than 1.75 inches.

20. (canceled)

21. The faucet of claim 8 wherein the lower disk further includes an outlet, the faucet further including an upper disk having a recess for selectively connecting the outlet and the inlet.

22. The faucet of claim 21 wherein the recess has a larger cross sectional area at the inlet.

23. A single control roman tub faucet comprising:
a handle;
a lever coupled to the handle; and
a cartridge valve coupled to the lever, the valve including first and second valve disks moveable relative to each other, one of the first and second valve disks including a pair of water inlet apertures and an outlet aperture, and the other of the first and second valve disks including a recess defining a water passage, the water passage having a first end wall, a second end wall and a pair of opposed sidewalls extending between the first and second end walls, the height of the sidewalls increasing from the first end wall to the second end wall.

24. The faucet of claim 23 wherein the depth of the water passage increases linearly.

25. The faucet of claim 23 wherein the first and second sidewalls are stepped.

26. The faucet of claim 23 wherein the configuration of the first and second valve disks provide a maximum flow rate of 7.8 GPM.

27. The faucet of claim 23 wherein the configuration of the first and second valve disks provide a maximum flow rate of 10.5 GPM.

28. The faucet of claim 23 wherein the configuration of the first and second valve disks provide a maximum flow rate of 12.5 GPM.
